(19) United States
(12) Patent Application Publication
(10) Pub. No.: US 2016/0098306 A1
(43) Pub. Date: Apr. 7, 2016

(54) HARDWARE QUEUE AUTOMATION FOR HARDWARE ENGINES

(71) Applicant: HGST Netherlands B.V., Amsterdam (NL)

(72) Inventors: Dar-Der Chang, San Jose, CA (US); Hsing H. Hsieh, San Jose, CA (US); Charles D. Potter, San Jose, CA (US)

(21) Appl. No.: 14/504,117

(22) Filed: Oct. 1, 2014

(51) Int. Cl. G06F 9/54; G06F 9/445

(52) U.S. Cl. CPC G06F 9/546; G06F 9/44505

(57) ABSTRACT

In general, techniques are described for performing hardware-based queue automation for hardware engines. An apparatus comprising a hardware engine and a hardware event queue manager may be configured to perform the techniques. The hardware event queue manager may be configured to receive, from a processing unit separate from the hardware event queue manager, an event to be processed by the hardware engine, and perform queue management with respect to an event queue to schedule processing of the event by the hardware engine.

### TECHNICAL FIELD

This disclosure relates to queue automation and more particularly to hardware-based event queue automation for hardware engines.

### BACKGROUND

In a typical computer, a processing unit (such as a central processing unit (CPU)) interfaces with various hardware engines to interact with various sensors. For example, a CPU may interface with a hardware engine to configure one or more sensors, i.e., one or more read/write lines in the example of a solid state drive (SSD). The CPU may execute software, such as an operating system, to manage interactions between the CPU and the hardware engine. The operating system may perform arbitration in multi-core CPUs, where each core effectively represents a different CPU, to determine which of the CPUs may access the hardware engine. The operating system may also perform queue management within the context of a single CPU to address how various events, such as read and write requests in the example of the SSD, issued by the CPU should be processed by the hardware engine of the SSD. Given that the operating system has what may be considered a “global view” of all the various requests by each of the CPUs and the utilization of the various hardware engines, the operating system may better handle the arbitration and queue management in terms of properly prioritizing CPU access to the various hardware engines and handling of the events by the various hardware engines.

While such global arbitration and queue management may promote better prioritization of CPU access and handling of the events, such software-based arbitration and queue management may impact CPU performance (e.g., in terms of decreasing available processing cycles for handling the execution of instructions to process new data by using these processing cycles to handle CPU arbitration and event processing). Various ways have been developed to facilitate CPU arbitration and event processing. For example, the operating system may be optimized to more efficiently handle events through concurrent event processing (assuming the events are independent) where the CPU handles various aspects of the event processing, such as event pre-processing and post-processing, concurrent to the hardware engine processing a different event. As another example, dedicated hardware may be provided, such as in an architecture commonly referred to as direct memory access (DMA), to offload oversight of the retrieval of data from an SSD, which may relieve some event handling oversight from being performed by the CPU especially when large contiguous blocks of data are requested to be either read or written. These examples, while promoting more efficient event handling, may still result require the CPU to consume processing cycles in even handling oversight (either in executing the optimized operating system or in overseeing the operation of the DMA controller).

### SUMMARY

In one example, a method comprises receiving, from a processing unit by a hardware event queue manager separate from the processing unit, an event to be processed by a hardware engine, and performing, by the hardware event queue manager, queue management with respect to an event queue to schedule processing of the event by the hardware engine.

In another example, an apparatus comprises a hardware engine, and a hardware event queue manager configured to receive, from a processing unit separate from the hardware event queue manager, an event to be processed by the hardware engine, and perform queue management with respect to an event queue to schedule processing of the event by the hardware engine.

In another example, an apparatus comprises means for receiving, from a processing unit by a hardware event queue manager separate from the processing unit, an event to be processed by a hardware engine, and means for performing, by the hardware event queue manager, queue management with respect to an event queue to schedule processing of the event by the hardware engine.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual and schematic block diagram illustrating an example storage environment in which a storage device may function as a storage device for a host device, in accordance with one or more techniques of this disclosure

FIG. 2 is a block diagram illustrating the hardware controller of FIG. 1 in more detail.

FIG. 3 is a flowchart illustrating exemplary operation of a hardware controller in performing various aspects of the queue automation techniques described in this disclosure.

FIG. 4 is a block diagram illustrating another example of a storage environment in which storage device may function as a storage device for host device, in accordance with one or more techniques of this disclosure.

FIG. 5 is a block diagram illustrating yet another example of a storage environment in which storage device may function as a storage device for host device, in accordance with one or more techniques of this disclosure.

FIG. 6 is a block diagram illustrating an example of a general computing environment in which hardware controller may provide a CPU access to a hardware engine, in accordance with one or more techniques of this disclosure.

### DETAILED DESCRIPTION

The techniques of this disclosure may relieve the processing unit of the overhead associated with managing event queues by offloading event queue management to a dedicated hardware event queue manager processing unit, thereby removing event handling from a global software driven context into a hardware per-event processing context. The processing unit may configure the hardware event queue manager based on configuration data defining a set of rules by which event handling is to proceed. The processing unit may embed additional information in an event issued the hardware event queue manager. The additional information may direct prioritization of the event and other aspects of event handling. The processing unit may issue multiple events in this manner without having to perform global event management to ensure proper handling of the event.

The hardware event queue manager may receive the events, assign, based on the embedded information, priorities to the events (e.g., by storing these events in an event queue in the appropriate order) and forward the events in the appropriate order to the hardware engine for processing. In the context of a storage device, the hardware engine may represent the hardware responsible for reading requested data or writing data. The hardware engine may issue an interrupt or otherwise interface with the processing unit when the event has been processed, whereupon the processing unit may retrieve the requested data in the example of a read request or acknowledge that the data was written in the example of a write request.

In this manner, a hardware event queue manager configured in according with techniques of this disclosure may offload event queue management from the processing unit and, in some instances, may perform processing unit arbitration in the context of multiple processing units. Because the hardware event queue manager may avoid interrupting the processing unit to perform these operations, the techniques may reduce access delays while promoting more processing unit throughput (given that fewer processing unit cycles may be consumed in event oversight).

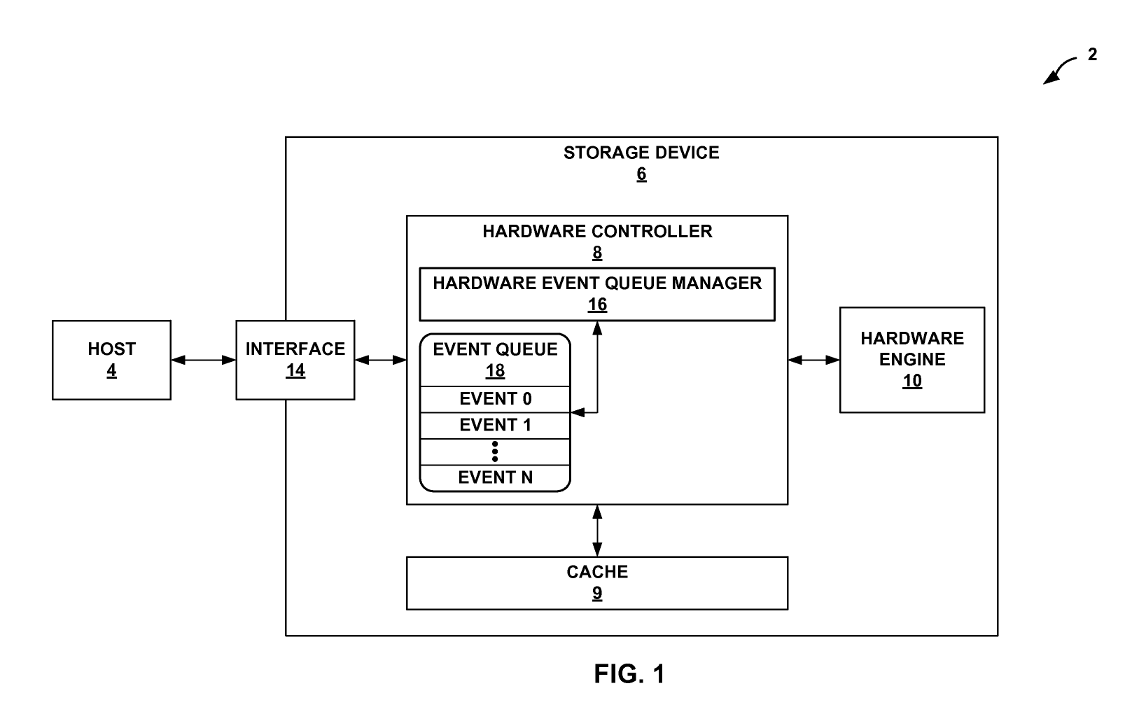

FIG. 1 is a conceptual and schematic block diagram illustrating an example storage environment 2 in which storage device 6 may function as a storage device for host device 4, in accordance with one or more techniques of this disclosure. For instance, host device 4 may utilize non-volatile memory devices included in storage device 6 to store and retrieve data. In some examples, storage environment 2 may include a plurality of storage devices, such as storage device 6, that may operate as a storage array. For instance, storage environment 2 may include a plurality of storages devices 6 configured as a redundant array of inexpensive/independent disks (RAID) that collectively function as a mass storage device for host device 4.

Storage environment 2 may include host device 4 which may store and/or retrieve data to and/or from one or more storage devices, such as storage device 6. As illustrated in FIG. 1, host device 4 may communicate with storage device 6 via interface 14. Host device 4 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like. Typically, host device 4 comprises any device having a processing unit, which may refer to any form of hardware capable of processing data and may include a general purpose processing unit (such as a central processing unit (CPU), dedicated hardware (such as an application specific integrated circuit (ASIC)), configurable hardware such as a field programmable gate array (FPGA) or any other form of processing unit configured by way of software instructions, microcode, firmware or the like.

As illustrated in FIG. 1 storage device 6 may include a hardware controller 8, a hardware engine 10, a cache 12, and an interface 14. In some examples, storage device 6 may include additional components not shown in FIG. 1 for ease of illustration purposes. For example, storage device 6 may include power delivery components, including, for example, a capacitor, super capacitor, or battery; a printed board (PB) to which components of storage device 6 are mechanically attached and which includes electrically conductive traces that electrically interconnect components of storage device 6, and the like. In some examples, the physical dimensions and connector configurations of storage device 6 may conform to one or more standard form factors. Some example standard form factors include, but are not limited to, 3.5″ hard disk drive (HDD), 2.5″ HDD, 1.8″ HDD, peripheral component interconnect (PCI), PCI-extended (PCI-X), PCI Express (PCIe) (e.g., PCIe x1, x4, x8, x16, PCIe Mini Card, MiniPCI, etc.). In some examples, storage device 6 may be directly coupled (e.g., directly soldered) to a motherboard of host device 4.

Storage device 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI), and PCI-express (PCIe). The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit storage device 6 to receive power from host device 4.

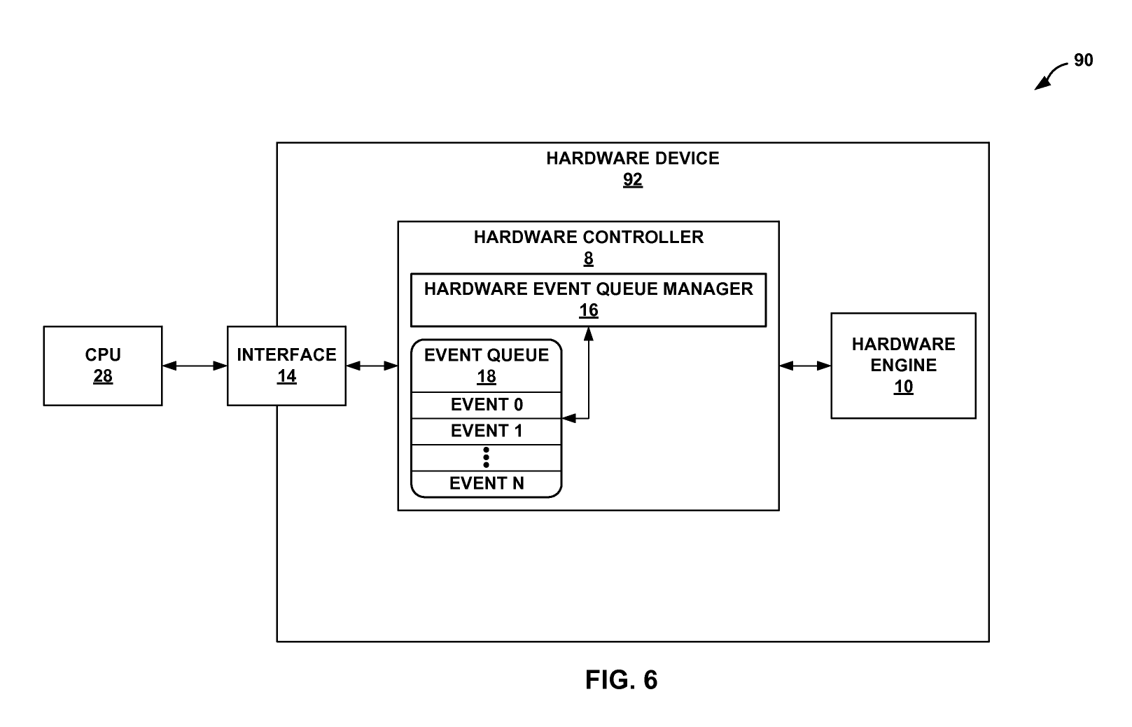

In the example of FIG. 1, storage device 6 includes hardware engine 10, which may represent the hardware responsible for interfacing with the storage medium. Hardware engine 10 may, in the context of a platter-based hard drive, represent the magnetic read/write head and the accompanying hardware to configure, drive and process the signals sensed by the magnetic read/write head. Hardware engine 10 may, in the context of flash memory-based hard drive (which may be referred to as a solid state drive or SSD), represent the hardware for interfacing with the flash memory. Although described in the following examples as being performed in the context of a storage device, the techniques described in this disclosure may be extended to any type of hardware engine as described in more detail below with respect to the example of FIG. 6.

Storage device 6 includes hardware controller 8, which may manage one or more operations of storage device 6. Hardware controller 8 may interface with host device 4 via interface 14 and manage the storage of data to and the retrieval of data from memory devices (not shown in the example of FIG. 1 for ease of illustration purposes) accessible via hardware engine 10. Hardware controller 20 may, as one example, manage writes to and reads from the memory devices, e.g., a Negated AND (NAND) flash memory chips.

Host 4 may, in this respect, interface with various hardware engines, such as hardware engine 10, to interact with various sensors. Host 4 may execute software, such as the above noted operating system, to manage interactions between host 4 and hardware engine 10. The operating system may perform arbitration in the context of multi-core CPUs, where each core effectively represents a different CPU, to determine which of the CPUs may access hardware engine 10. The operating system may also perform queue management within the context of a single CPU to address how various events, such as read and write requests in the example of storage device 6, issued by host 4 should be processed by hardware engine 10 of storage device 6. Given that the operating system has what may be considered a “global view” of all the various requests by each of the CPUs and the utilization of the various hardware engines, the operating system may better handle the arbitration and queue management in terms of properly prioritizing CPU access to the various hardware engines and handling of the events by the various hardware engines.

While such global arbitration and queue management may promote better prioritization of CPU access and handling of the events, such software-based arbitration and queue management may impact CPU performance (e.g., in terms of decreasing available processing cycles for handling the execution of instructions to process new data by using these processing cycles to handle CPU arbitration and event processing). Various ways have been developed to facilitate CPU arbitration and event processing. For example, the operating system may be optimized to more efficiently handle events through concurrent event processing (assuming the events are independent) where the CPU handles various aspects of the event processing, such as event pre-processing and post-processing, concurrent to the hardware engine processing a different event. As another example, dedicated hardware may be provided, such as in an architecture commonly referred to as direct memory access (DMA), to offload oversight of the retrieval of data from a drive (either hard drive or SSD), which may relieve some event handling oversight from being performed by the CPU especially when large contiguous blocks of data are requested to be either read or written. These examples, while promoting more efficient event handling, may still result require the CPU to consume processing cycles in even handling oversight (either in executing the optimized operating system or in overseeing the operation of the DMA controller).

To illustrate, consider an architecture that involves a PCIe SSD where ten (10) or more general-purpose CPUs are each attempting to access one or more hardware engines. These CPUs may execute event handling and arbitration algorithms in an attempt to facilitate some form of “fair” access to the hardware engines, which may consume processor cycles that could otherwise be employed in executing threads directed to processing actual data and instructions related to an actual task.

As another illustration, consider an architecture that includes a SAS SSD where a number of CPUs operate in a so-called “fiber” multi-task system. These CPUs may be assigned to performing particular functions, such as SAS, caching and back-end operations (e.g., related to NAND flash). In some instances, these CPUs may be statically assigned one or more hardware engines to support the corresponding operation. When there are long delays in processing at the hardware engines, the CPUs may become idle and may attempt to access another hardware engine in an attempt to continue process events. As a result, even in dedicated “fiber” multi-task environments, the idle CPU may perform hardware engine arbitration and event queuing, which as noted above may consume processor cycles.

As a further illustration, consider an architecture that includes a hard disk drive (HDD), where a single CPU is able to more quickly process events than the hardware engine. The CPU may, in this HDD context, pre-calculate the next track hardware settings to shrink the inter-track operation overhead while waiting for the current track completed. The CPU may therefore utilize processor cycles performing pre-event processing that could otherwise be used for different data processing unrelated to internal management of event processing.

The techniques of this disclosure may enable a dedicated hardware event queue manager 16 that allows a processing unit, separate from hardware event queue manager 16 (e.g., included within host 4 separate from storage device 6), to offload event handling, thereby removing event handling from a global software driven context into a hardware per-event processing context. Host 4 may first configure hardware event queue manager 16 based on configuration data defining a set of rules by which event handling is to proceed. Host 4 may then issue an event to hardware event queue manager 16, embedding some additional information in the event to direct prioritization and other aspects of event handling. The processing unit may issue multiple events in this manner without having to perform global event management to ensure proper handling of the event.

Hardware event queue manager 16 may receive the events, assign priorities to the events (e.g., by storing these events in an event queue 18 in the appropriate order) and handle the forwarding of the events in the appropriate order to hardware engine 10 for processing. In the context of storage device 6, hardware engine 10 may represent the hardware responsible for retrieving the requested data or write the requested data to the memory devices. Hardware engine 10 may issue an interrupt or otherwise interface with host 4 when the event has been processed, whereupon host 4 may retrieve the requested data in the example of a read request or acknowledge that the data was written in the example of a write request.

Hardware event queue manager 16 may therefore perform event management in terms of overseeing proper event prioritization (which may refer to queuing) and, in some instances, perform processing unit arbitration in the context of multiple processing units. Because hardware event queue manager 16 may not interrupt host 4 to perform these operations, the techniques may reduce access delays while promoting more processing unit throughput (given that fewer processing unit cycles may be consumed in event oversight). In the context of a PCIe SSD, the techniques may offload event prioritization and CPU arbitration from the 10 or more CPUs, allowing those CPUs to execute instructions and process data unrelated to internal event processing management. In the context of SAS SSDs of “fiber” multi-task systems, the techniques may allow idle CPUs to more quickly access hardware engines by reducing the amount of processor cycles used to access a hardware engine for purposes of event processing. In other words, when the hardware engine 10 is included in an SSD (such as a PCIe SSD), the techniques may offload event queue management to a hardware event queue manager 16, where the event in this context may represent a request to access the hardware engine so as to interact with a memory (NAND flash memory) of the solid state drive. In the context of hard drives, the techniques may offload event pre-process, event prioritization and arbitration from the CPU to the dedicated hardware event queue manager, potentially facilitating more effective use of processor cycles on tasks unrelated to internal event processing.

In operation, hardware controller 8 is configured in accordance with the techniques described in this disclosure to include hardware event queue manager 16. Hardware event queue manager 16 receives, from a processing unit located in host 4 and via interface 14, an event to be processed by hardware engine 10. This event, as noted above, may include a request to access hardware engine 10 (e.g., such as a read request or a write request to be handled by hardware engine 10) and additional information indicating how hardware event queue manager 16 is to perform the queue management in order to schedule the processing of the event by hardware engine 10.

Hardware event queue manager 16 may then perform queue management with respect to event queue 18 to schedule processing of the event by hardware engine 10. Event queue 18 may represent a so-called priority queue, where each element of the queue is associated with a priority. Event queue 18 may be implemented using a heap data structure or a binary search tree data structure. Event queue 18 may however be implemented in any number of different ways, e.g., using a stack, an unordered array, a queue, a graph , or any other form of data structure capable of being adapted to accommodate priorities. Having been configured with various rules to prioritize and store the events, hardware event queue manager 16 may store the event to event queue 18 based on, at least in part, the configuration data defining these rules and the additional information accompanying the event.

In some examples, hardware event queue manager 16 may store the event itself to event queue 18. In other examples, hardware event queue manager 16 may store a pointer to the event in the event queue 18 rather than the event itself (where the pointer may, in the computer programming arts, represent a memory address at which the event is stored, for example, in cache 9). Hardware event queue manager 16 may then pass the next event (either directly from event queue 18 or after dereferencing the pointer to retrieve the event from the memory address specified by the pointer in cache 9) to hardware engine 10. Hardware event queue manager 16 may retrieve the next event as the highest priority event currently stored to event queue 18. Hardware event queue manager 16 may provide all of the information necessary to process the event, performing event pre-processing without having to interrupt or otherwise communicate with host 4. Hardware event queue manager 16 may, once the event has been processed by hardware engine 10, perform event post-processing without having to interrupt or otherwise communicate with host 4. Once post-processing has been completed, hardware event queue manager 16 may issue an interrupt to host 4 to signal completion of the request. Hardware event queue manager 16 may then select the next event and repeat the process without interrupting or otherwise communicating with host 4, thereby reducing oversight of event processing by host 4 and promoting more efficient event processing.

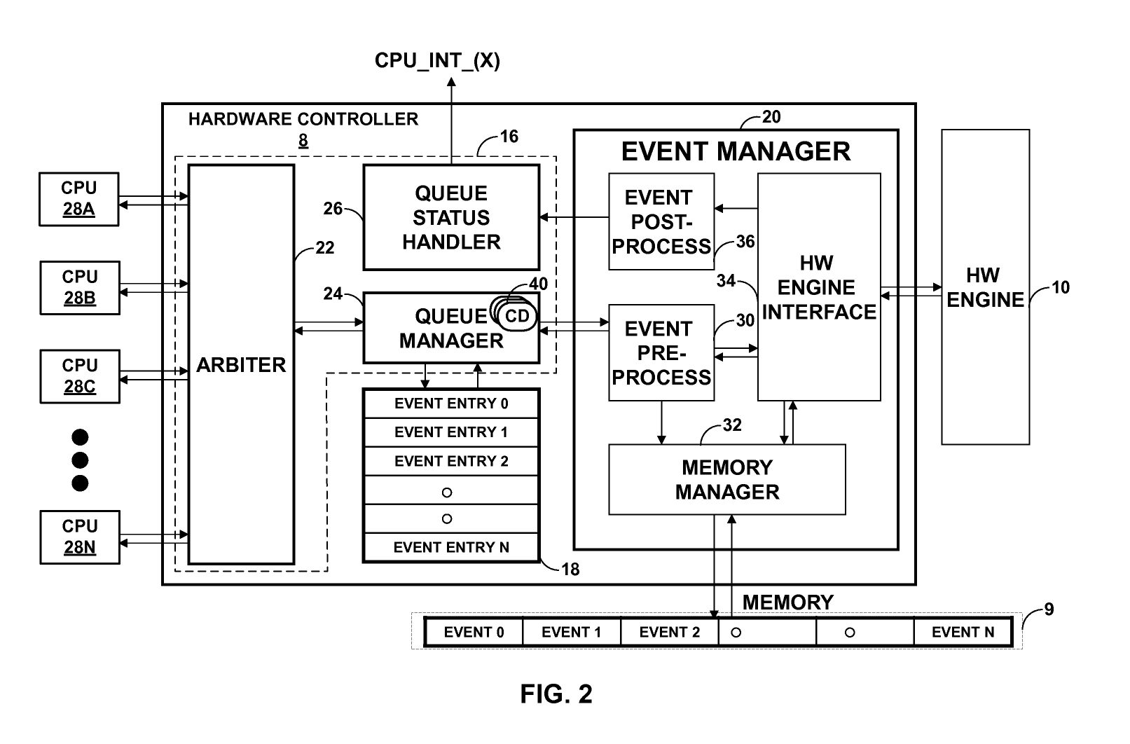

FIG. 2 is a block diagram illustrating hardware controller 8 of FIG. 1 in more detail. In the example of FIG. 2, hardware controller 8 includes hardware event queue manager 16 and an event manager 20. Hardware event queue manager 16 includes an arbiter unit 22, a queue manager unit 24, and a queue status handler unit 26. Arbiter unit 22 represent a unit configured to perform arbitration for access to hardware controller 8 by central processing units (CPUs) 28A-28N (“CPUs 28”). As noted above, in multi-core or multi-processing units systems, two or more CPUs 28 may each attempt to access hardware controller 8. Arbiter unit 22 may implement some form of arbitration, such as a round robin algorithm, deficit round robin algorithm, weighted round robin or some other scheduling algorithm, to determine which of the two or more CPUs 28 attempting to access hardware controller 8 should be granted access to hardware controller 8. Arbiter unit 22 may perform this arbitration in an attempt to provide equal and/or fair access to hardware controller 8 to each of the requesting ones of CPUs 28. Arbiter unit 22 may, in this respect, represent a hardware-based arbitration unit that performs arbitration in a manner that effectively offloads arbitration from being performed by the operation system or other software executed by any of CPUs 28. Arbiter unit 22 may therefore not communicate or otherwise interrupt CPUs 28 to identify which of CPUs 28 is to be granted access to hardware controller 8 but rather may automatically (meaning, for example, without user or CPU intervention) perform arbitration to grant access to hardware controller 8. In this respect, arbiter unit 22 arbitrates different CPU requests to be processed.

Queue manager unit 24 may represent a unit configured to perform the above noted hardware-based event queue management with respect to event queue 18. Queue manager unit 24 may receive events from the one of CPUs 28 granted access to hardware controller 8, assign a priority to those events based on the rules defined by the configuration data and the additional information included within the event, and queue the prioritized event within event queue 18. Queue manager 24 may perform this event prioritization and queueing without interrupting or otherwise communicating with the one of CPUs 28. In this respect, CPUs 28 need not execute software to perform this event prioritization and queue management. Instead, queue manager 24 may provide events stored to event queue 18 to event manager 20 for processing by hardware engine 10 without having to interrupt or otherwise communicate with CPUs 28 (or, more typically, the software executed by CPUs 28) to determine which of the events are to be processed next. Queue manager 24 may automatically (meaning, without user or CPU intervention) provide events to event manager 20 for processing by hardware engine 10. In this respect, queue manager 24, once a CPU request is accepted, queues the event entry, which is processed when the event manager is ready.

Although described as performing queue management with respect to an event queue 18 with events stored to an internal cache 9, queue manager 24 may utilize an external memory for queue 18, which may be useful for large queue sizes. In some examples, the number of events are created faster than the number of events that hardware engine 10 can process. In these examples, queue manager 24 may require a large queue, which may be better stored to external memory rather than utilizing internal memory, such as cache 9, which is generally in short supply and used for a number of different purposes outside of queue management.

Queue status handler unit 26 may represent a unit configured to report status updates via interrupts (as one example) to CPUs 28. These interrupts (CPU_INT_(X), where the X denotes an variable by which one of CPUs 28 may be identified) may communicate to the corresponding X one of CPUs 28 that a read request is complete and data is waiting at a pre-defined location for retrieval by the X one of CPUs 28 or that a write request is complete. These interrupts may also identify various other statuses that may require CPU intervention, such as an error (due to any number of issues, such as when error correction fails and the data are corrupt). Queue status handler unit 26 may monitor CPU activities and interrupt an idle one of CPUs 28 to process the next instruction.

Event manager 20 represents a unit configured to manage event processing by hardware engine 10. Event manager 20 may facilitate event processing by performing event pre-processing, memory management and event post-processing. To this end, event manager 20 includes, as shown in the example of FIG. 2, an event pre-process unit 30, a memory management unit 32, a hardware (HW) engine interface unit 34, and an event post-processing unit 36. Event pre-processing unit 30 may represent a unit configured to receive an event stored to event queue 18 from queue manager unit 24 and perform event pre-processing with respect to the event. As noted above, the event stored to event queue 18 may, in some examples, include a pointer identifying a location in cache 9 where the actual event is stored. To retrieve the actual event, event pre-process unit 30 may pass the pointer (which may also be referred to as an “event pointer”) to memory manager unit 32. The memory manager unit 32 may then dereference the event pointer to retrieve the event and pass the event to the hardware engine interface 34. Memory manager unit 32 may represent a unit configured to provide memory access that can be either single or multiple memory partition that will be used by hardware engine 10 and CPUs 28.

Event pre-processing unit 30 may next prepare the event for processing by hardware engine 10. Event pre-processing unit 30 may perform this pre-processing by at least in part providing configuration data or other data to configure the hardware engine 10 to process the event. Even pre-processing unit 30 may setup memory that will be loaded and stored by hardware engine 10 and initiate hardware engine 10 operation via hardware engine interface 34. Examples of pre-processing activities may include, in the context of a 64-bit bus memory, loading data to a register from memory, storing data from a register to the memory, setting bits in between two registers using a logical ‘OR’ operation, clearing bits using between two registers using a logical ‘AND’ operation, complementing bits using an between two registers using a logical ‘XOR’ operation, waiting some number of nanoseconds or milliseconds (to provide extra time to set registers), and pre-fetch to first-in-first-out (FIFO) queue.

A potential scheme by which to enable these pre-processing commands in the context of a PCIe SSD is provided below:
Command: Bit 63 . . . 58
   Load: Data (bit 32 . . . 0)to Register
   Store: Register to Data (bit 32 . . . 0)
   Bit Set: Data (bit 32 . . . 0) ‘OR’ Register to Register
   Bit Clear: Data (bit 32 . . . 0) ‘AND’ Register to Register
   Bit Complement: Data (bit 31 . . . 0) ‘XOR’ Register to Register
   Wait in ns (example: some registers setting requires time to be stable before start Engine)
   Wait in ms
      In the foregoing scheme, bits 63-58 of the 64-bit (where 63 refers to the 64^{th} bit given that there is a bit 0 as is common in programming and computer-hardware architectures) may be used to identify one or more of the load, store, bit set, bit clear, bit complement, wait in nanoseconds (ns) or wait in millisecond (ms) commands.

Hardware engine interface unit 34 may represent a unit configured to facilitate communications between the hardware controller 8 and the hardware engine 10. Hardware engine interface unit 34 may present a standardized or uniform way by which to interface with hardware engine 10. Hardware engine interface 34 may provide the configuration data and the event to the hardware engine 10, which may then process the event in accordance with the configuration data, returning various different types of information depending on the event. In the context of an event requesting that data be read (e.g., a read request), hardware engine 10 may return the data to hardware engine interface 34, which may pass the data to memory manager unit 32. Memory manager unit 32 may store the read data to cache 9 and return a pointer or other indication of where this read data is stored to hardware engine interface 34. Hardware engine interface 34 may pass this pointer to event post-process unit 36. In the context of an event involving a request to write data (e.g. a write request), hardware engine 10 may return an indication that the write has completed to hardware engine interface unit 34, which may pass this indication to event post-process unit 36. In this respect, hardware engine interface unit 34 may provide a protocol and handshake mechanism with which to interface with hardware engine 10.

Event post-process unit 36 may represent a unit configured to perform post-processing with respect to an event after having been processed by the hardware engine 10. Event post-process unit 36 may for example receive the data pointer identifying a location in cache 9 of read data, dereference the data pointer to retrieve the data and perform post processing with respect to this read data. This post processing may include perform error correction, decryption or any other forms of post processing generally applied after an event has been serviced by a hardware engine. Event post-processing in the context of a write request may involve a wait for the engine to stop processing with a timeout in nanoseconds or in milliseconds, pre-fetch operations to a first-in-first-out (FIFO) queue, and a flush FIFO queue to memory operations. Event post-process unit 36 may pass a status of the event processing to the queue status handler 16, which may issue the interrupts as described above. Even post-process unit 36 may, in other words, monitor a status of hardware engine 10 and provide results to queue status handler unit 26.

In operation, CPUs 28 may each, upon initially being granted access to hardware controller 8 after powering on or otherwise becoming operational, provide configuration data 40 (“CD 40”) to hardware controller 8. Configuration data 40 may provide the above noted rules or other conditions to be used by queue manager 40 when processing events from the respective one of CPUs 28. More specifically, software executed by CPUs 28 may generate and provide this configuration data 40 to hardware controller 8, which may pass configuration data 40 to queue manager 24 for use in assigning priorities to events generated by the software executed by CPUs 28. In this respect, a single one of CPUs 28, e.g., CPU 28A, may execute multiple different software threads, where each of these threads may provide different configuration data 40 to hardware controller 8.

In any event, arbiter 22 may arbitrate between concurrent requests to access hardware controller 8, granting access to one of CPUs 28. Assuming arbiter 22 grants CPU 28A access to hardware controller 8, CPU 28A may issue an event (e.g., event 0) to hardware controller 8, whereupon arbiter 28A may pass event 0 to queue manager 40. This event may identify the respective one of software threads that issued the event (e.g., as part of the above noted additional information included within the event) such that queue manager 24 may select the corresponding one of configuration data 40 to use when assigning a priority to event 0. Queue manager 24 may then assign the event a priority, storing this event 0 to event queue 18. Queue manager 24 may continue to receive events from this software thread, queuing the events for processing by hardware engine 10 to event queue 18. Queue manager 24 may also dequeue an event from event queue 18, passing these events to event pre-process unit 30 of event manager 20.

Event pre-process unit 30 performs pre-processing of the event, passing the event (which is assumed for purposes of illustration to be an event pointer) to memory manager 32. Memory manager 32 may dereference the event pointer to retrieve the event. Memory manager 32 may then pass the event to hardware engine interface 34, while event pre-process unit 30 provides the above noted pre-process information to hardware engine interface 34. Hardware engine interface 34 may then provide the event and the pre-process information to hardware engine 10. Hardware engine 10 may then process the event, providing the above noted information back to hardware engine interface 34.

Hardware engine interface 34 provides the information to either the event pre-process unit 30 and/or the event post-process unit 36. That is, hardware engine interface 34 may provide information indicative of the result of processing the event to event pre-process unit 30 when processing of the event triggers a new event to be generated. As a result of triggering the new event, event pre-process unit 30 may perform pre-processing with respect to this new event, while also interfacing with memory manager 32 to provide the new event to hardware engine interface 34. Hardware engine interface 34 may provide the information indicative of the result of processing the event to event post-process unit 36 whether or not a new event is triggered from processing of the previous event. Event post process unit 36 may perform the above noted post-processing. After performing the post-processing, event post-process unit 36 may then interface with queue status handler 16 to generate an interrupt for the corresponding one of CPUs 28. The interface, as noted above, may notify the one of CPUs 28 of the completion of processing the event and provide any other information that the one of CPUs 28 may require as a result of processing the event (e.g., a pointer to cache 9 identifying the data read as a result of processing an event requesting that data be read from an SSD, such as a PCIe SSD).

The foregoing process may continue, where arbiter 22 may grant access to another one of CPUs 28, which will then generate events that queue manager 24 queues to event queue 18 in accordance with the corresponding one of configuration data 40. Queue manager 40 may pass these events to event manager 20, which pre-processes these events and provides the event to hardware engine 10. Hardware engine 10 processes the event and provides the results to hardware engine interface 34, which passes these results to event post-process unit 36. Event post-process unit 36 may perform post-processing with respect to these results and interface with queue status handler 26 to issue an interrupt to the corresponding one of CPUs 28.

In this respect, the techniques may reduce locking period of CPUs 28 on hardware engine 10 by reducing or eliminating the potential need of those CPUs 28 to build programming lists for hardware engine 10, set registers before hardware engine 10 is started and get registers after hardware engine 10 has stopped. CPUs 28 may also no longer need to service pending tasks/events. In this respect, the techniques may provide a queue for the hardware engine 10 to save the pending programming list pointers and an interrupt or hardware support to get an idle one of CPUs 28 to service status and results, which are already copied to memory by hardware controller 8 in accordance with the techniques described in this disclosure. The techniques further provide for arbiter 22, for each CPU to load a programming list pointer to queue 18. Furthermore, as noted above, the techniques may provide for automatic processing of the next event without requiring any CPU intervention. The event pointed by the next programming list pointer is, in this respect, popped out form the head of queue 18 automatically when queue 18 is not empty, which triggers the automation to setup registers and start hardware engine 10.

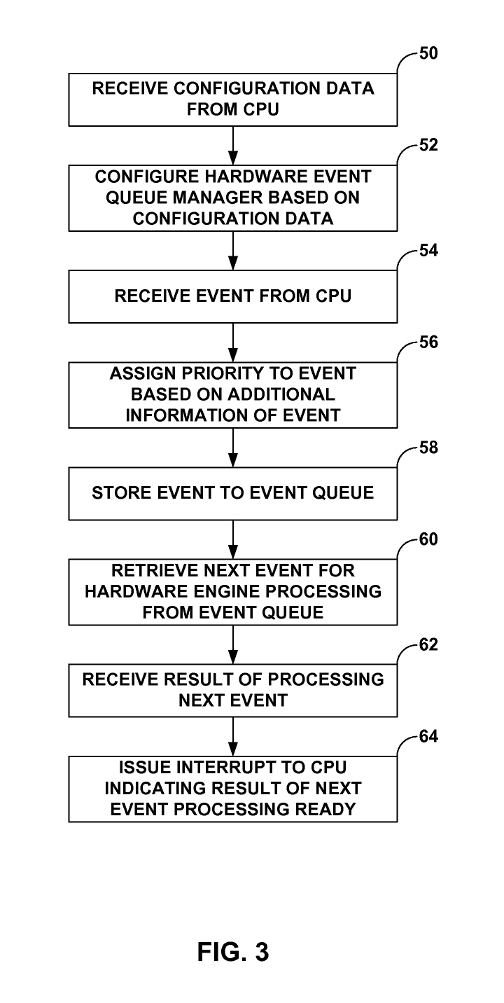

FIG. 3 is a flowchart illustrating exemplary operation of a hardware controller, such as hardware controller 8 shown in the example of FIG. 2, in performing various aspects of the queue automation techniques described in this disclosure. Initially, CPUs 28 may each, upon initially being granted access to hardware controller 8 after powering on or otherwise becoming operational, provide configuration data 40 (“CD 40”) to hardware controller 8. Hardware controller 8 may receive this configuration data 40 from one of CPUs 28 and pass configuration data 40 to queue manager 24 for use in assigning priorities to events generated by the software executed by CPUs 28 (50). Hardware event queue manager 16 may configured queue manager 40 based on this configuration data 40 in the manner described above in more detail (52).

After arbitration performed in the manner described above, queue manager 40 may receive an event from one of CPUs 28 (54). This event may identify the respective one of software threads that issued the event (e.g., as part of the above noted additional information included within the event) such that queue manager 24 may select the corresponding one of configuration data 40 to use when assigning a priority to event 0. Queue manager 24 may then assign the event a priority based on the additional information (and the corresponding configuration data), storing this event 0 to event queue 18 (56, 58). Queue manager 24 may continue to receive events from this software thread, queuing the events for processing by hardware engine 10 to event queue 18. Queue manager 24 may also dequeue or otherwise retrieve an event from event queue 18, passing these events to event pre-process unit 30 of event manager 20 (60).

Event pre-process unit 30 performs pre-processing of the event, passing the event (which is assumed for purposes of illustration to be an event pointer) to memory manager 32. Memory manager 32 may dereference the event pointer to retrieve the event. Memory manager 32 may then pass the event to hardware engine interface 34, while event pre-process unit 30 provides the above noted pre-process information to hardware engine interface 34. Hardware engine interface 34 may then provide the event and the pre-process information to hardware engine 10. Hardware engine 10 may then process the event, providing the above noted information back to hardware engine interface 34.

Hardware engine interface 34 provides the information to either the event pre-process unit 30 and/or the event post-process unit 36. That is, hardware engine interface 34 may provide information indicative of the result of processing the event to event pre-process unit 30 when processing of the event triggers a new event to be generated. As a result of triggering the new event, event pre-process unit 30 may perform pre-processing with respect to this new event, while also interfacing with memory manager 32 to provide the new event to hardware engine interface 34. Hardware engine interface 34 may provide the information indicative of the result of processing the event to event post-process unit 36 whether or not a new event is triggered from processing of the previous event. Event post process unit 36 may perform the above noted post-processing. After performing the post-processing, event post-process unit 36 may then interface with queue status handler 16 to generate an interrupt for the corresponding one of CPUs 28. In this respect, hardware event queue manager 16 may receive the result of processing the next event and issue an interrupt to the one of CPUs 28 indicating a result of the next event processing is ready (62, 64).

The foregoing process may continue, where arbiter 22 may grant access to another one of CPUs 28, which will then generate events that queue manager 24 queues to event queue 18 in accordance with the corresponding one of configuration data 40. Queue manager 40 may pass these events to event manager 20, which pre-processes these events and provides the event to hardware engine 10. Hardware engine 10 processes the event and provides the results to hardware engine interface 34, which passes these results to event post-process unit 36. Event post-process unit 36 may perform post-processing with respect to these results and interface with queue status handler 26 to issue an interrupt to the corresponding one of CPUs 28.

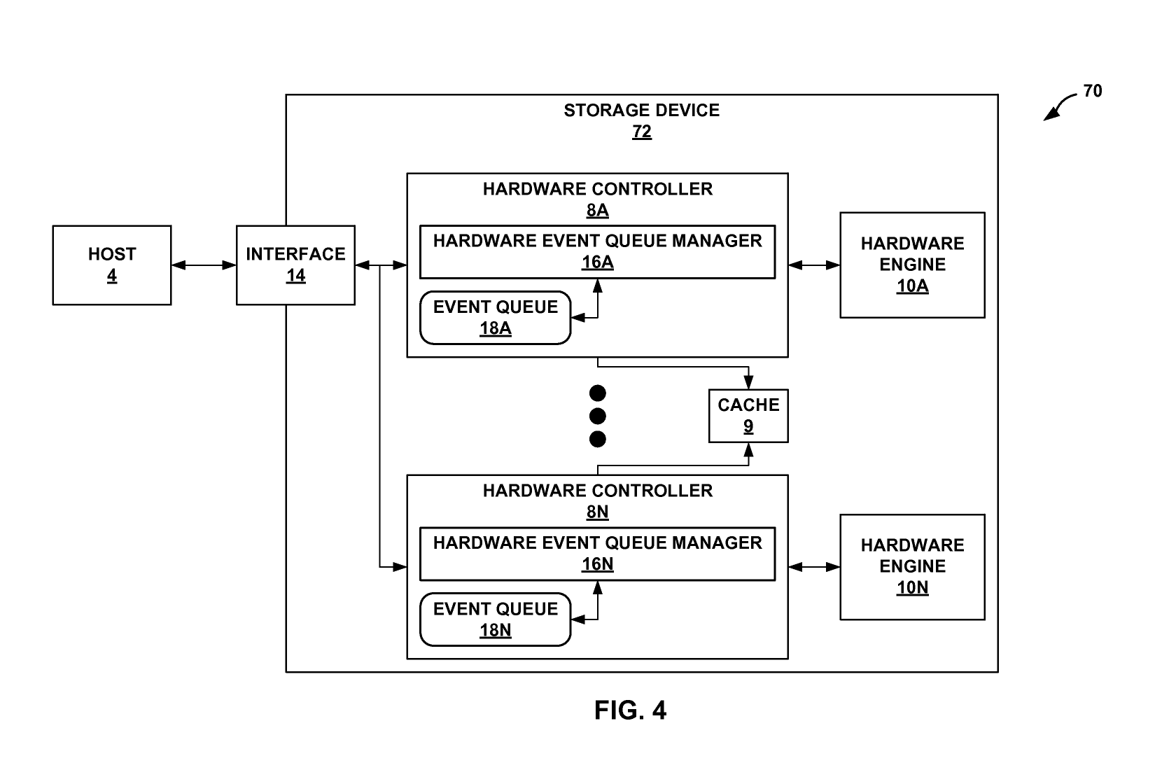

FIG. 4 is a block diagram illustrating another example of a storage environment 70 in which storage device 72 may function as a storage device for host device 4, in accordance with one or more techniques of this disclosure. Storage environment 70 may be similar to storage environment 2, except that storage device 72 of storage environment 70 includes multiple hardware engines 10A-10N, each of which is associated with a separate hardware controller 8A-8N. Each one of hardware controllers 8A-8N includes a different hardware event queue manager 16A-16N that manages a separate one of event queues 18A-18N. In this respect, the techniques may accommodate a large number of hardware engines 10, each of which have a dedicated hardware controller 8 to automate queue management, arbitration and event pre- and post-processing.

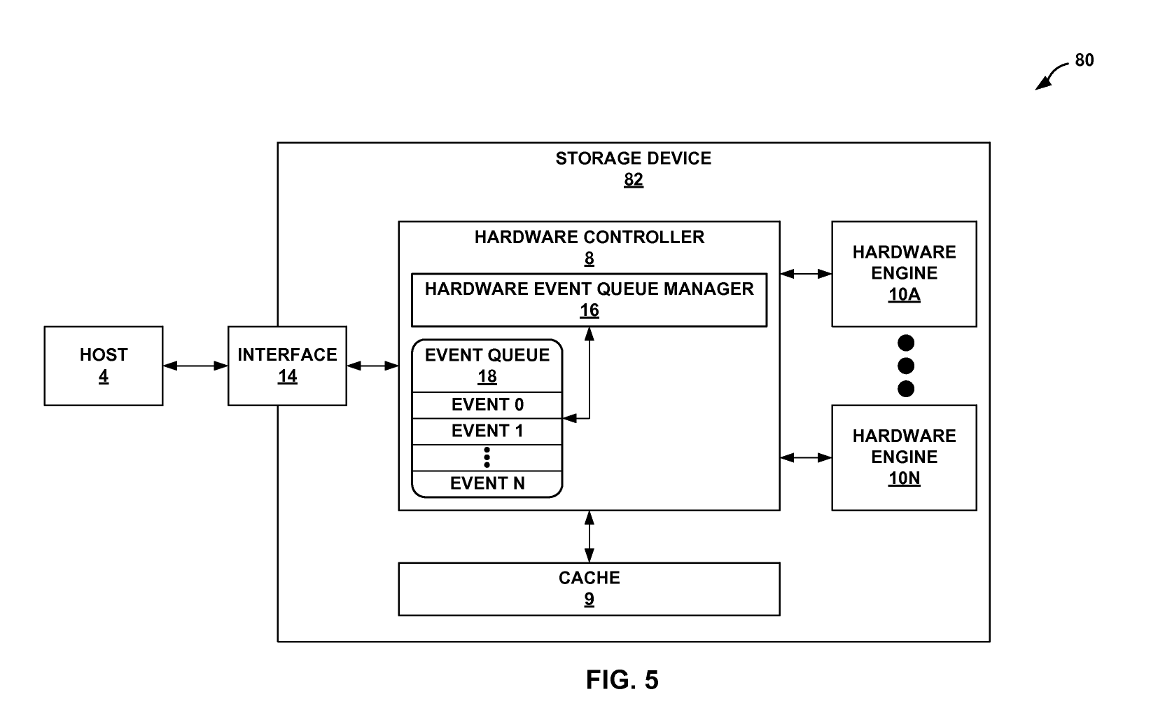

FIG. 5 is a block diagram illustrating yet another example of a storage environment 80 in which storage device 82 may function as a storage device for host device 4, in accordance with one or more techniques of this disclosure. Storage environment 80 may be similar to storage environments 2 and 70, except that storage device 82 of storage environment 80 includes multiple hardware engines 10A-10N, each of which are associated with a same hardware controller 8. Given that the cost may be high to provide queue automation for each of hardware engines 10A-10N, a single hardware controller 8 may provide queue automation in the form of hardware event queue management unit 16 for each of hardware engines 10A-10N. This implementation may be useful when hardware engines 10A-10N are not executed frequently and hardware event queue manager unit 16 has enough bandwidth. To share queue automation, the queuing algorithm may be modified in or more of the following ways:
1) Create multiple queues in an automation; or
2) Share a single queue (events may not always dequeued from the head of the queue because the event at the head of the queue may try to use one of hardware engines 10A-10N that is currently busy with a previous event).
   As such, the queuing algorithm may be modified to provide a scan mechanism that searches the queue 18 for an idle one of hardware engines 10A-10N, skipping those events marked as ‘done.’

FIG. 6 is a block diagram illustrating an example of a general computing environment 90 in which hardware controller 92 may provide a CPU 28 access to a hardware engine 10, in accordance with one or more techniques of this disclosure. Computing environment 90 is a more general environment than the storage environments discussed above. In other words, the techniques described in this disclosure should not be limited to storage environments but may be extended to any computing environment in which a CPU, such as CPU 28, or other processing units interface with a hardware controller 8 to access hardware engine 10. Accordingly, the techniques may be extended to nearly any computing environment 90 having a CPU 28 and a hardware engine 10 that may benefit from automated queue management.

The techniques described in this disclosure may be implemented, at least in part, in hardware, software, firmware, or any combination thereof. For example, various aspects of the described techniques may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processing units, or other processing units, to implement one or more of the techniques described herein, such as when instructions included or encoded in the computer-readable storage medium are executed by the one or more processing units. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
receiving, from a processing unit by a hardware event queue manager separate from the processing unit, an event to be processed by a hardware engine; and
performing, by the hardware event queue manager, queue management with respect to an event queue to schedule processing of the event by the hardware engine.

2. The method of claim 1, wherein the event includes a request to access the hardware engine and additional information indicating how the hardware event queue manager is to perform the queue management in order to schedule the processing of the event by the hardware engine.

3. The method of claim 1,
wherein the processing unit comprises one of a plurality of processing units, and wherein the method further comprises:
receiving, by the hardware event queue manager, requests to access the hardware engine from two or more of the plurality of processing units;
arbitrating, by the hardware event queue manager, between the requests to determine which one of the requests is to be granted; and
granting, by the hardware event queue manager, the one of the requests to access the hardware engine based on the arbitration.

4. The method of claim 3, wherein arbitrating between the requests comprises arbitrating between the requests based on a round-robin arbitration algorithm to determine which of the request to access the hardware engine are to be granted.

5. The method of claim 1,
wherein the hardware engine comprises one of a plurality of hardware engines,
wherein the hardware event queue manager comprises one of a plurality of hardware event queue managers, each of the hardware event queue managers corresponding to a respective one of the plurality of hardware engines,
wherein receiving the event comprises receiving, by the plurality of hardware event queue managers, events to be processed by the corresponding ones of the plurality of hardware engines, and
wherein performing the queue management comprises performing, by the plurality of hardware event queue managers, the queue management with respect to respective event queues to schedule processing of the events by the corresponding one of the plurality of hardware engines.

6. The method of claim 1,
wherein the hardware engine comprises one of a plurality of hardware engines,
wherein the hardware event queue manager is associated with each of the plurality of hardware engines and includes a respective event queue for each of the plurality of hardware engines,
wherein receiving the event comprises receiving, by the hardware event queue manager, events to be processed by the plurality of hardware engines, and
wherein performing the queue management comprises performing, by the hardware event queue manager, the queue management with respect to the respective event queues to schedule processing of the events by the corresponding one of the plurality of hardware engines.

7. The method of claim 1,
wherein the hardware engine comprises one of a plurality of hardware engines,
wherein the hardware event queue manager is associated with each of the plurality of hardware engines and includes a single event queue for the plurality of hardware engines,
wherein receiving the event comprises receiving, by the hardware event queue manager, events to be processed by the plurality of hardware engines, and
wherein performing the queue management comprises performing, by the hardware event queue manager, the queue management with respect to the event queue to schedule processing of the events by the plurality of hardware engines.

8. The method of claim 1,
wherein the hardware engine comprises a hardware engine of a storage device that processes one or more of a read request and a write request,
wherein the event comprise one of the read request or the write request, and
wherein the hardware event queue manager comprises a hardware controller of the storage device.

9. The method of claim 1, further comprising:
receiving, by the hardware event queue manager, configuration information specifying rules for performing the queue management; and
configuring, by the hardware event queue manager, the queue management in accordance with the configuration information.

10. The method of claim 1, further comprising:
receiving, by the hardware event queue manager, configuration information specifying rules for performing the queue management; and
configuring, by the hardware event queue manager, the queue management in accordance with the configuration information,
wherein the event includes a request to access the hardware engine and additional information indicating how the hardware event queue manager is to perform the queue management in order to schedule the processing of the event by the hardware engine,
wherein performing the queue management comprises performing the queue management with respect to the event queue in accordance with the configuration information and the additional information to schedule processing of the event by the hardware engine.

11. The method of claim 1, further comprising:
processing, by the hardware engine, the event; and
returning a result of processing the event to the processing unit.

12. The method of claim 1,
wherein the hardware engine is included within a solid state drive;
wherein the event includes a request to access the hardware engine so as to interact with a memory of the solid state drive.

13. The method of claim 12, wherein the solid state drive is a peripheral component interconnect Express (PCIe) solid state drive.

14. An apparatus comprising:
a hardware engine; and
a hardware event queue manager configured to receive, from a processing unit separate from the hardware event queue manager, an event to be processed by the hardware engine, and perform queue management with respect to an event queue to schedule processing of the event by the hardware engine.

15. The apparatus of claim 14, wherein the event includes a request to access the hardware engine and additional information indicating how the hardware event queue manager is to perform the queue management in order to schedule the processing of the event by the hardware engine.

16. The apparatus of claim 14,
wherein the processing unit comprises one of a plurality of processing units, and
wherein the hardware event queue manager is further configured to receive requests to access the hardware engine from two or more of the plurality of processing units, arbitrates between the requests to determine which one of the requests is to be granted, and grants the one of the requests to access the hardware engine based on the arbitration.

17. The apparatus of claim 16, wherein the hardware event queue manager is further configured to arbitrate between the requests based on a round-robin arbitration algorithm to determine which of the request to access the hardware engine are to be granted.

18. The apparatus of claim 14,
wherein the hardware engine comprises one of a plurality of hardware engines,
wherein the hardware event queue manager comprises one of a plurality of hardware event queue managers, each of the hardware event queue managers corresponding to a respective one of the plurality of hardware engines,
wherein the plurality of hardware event queue managers are configured to receive events to be processed by the corresponding ones of the plurality of hardware engines, and perform the queue management with respect to respective event queues to schedule processing of the events by the corresponding one of the plurality of hardware engines.

19. The apparatus of claim 14,
wherein the hardware engine comprises one of a plurality of hardware engines,
wherein the hardware event queue manager is associated with each of the plurality of hardware engines and includes an event queue for the plurality of hardware engines,
wherein the hardware event queue manager receives events to be processed by the plurality of hardware engines, and performs the queue management with respect to the event queue to schedule processing of the events by the corresponding one of the plurality of hardware engines.

20. The apparatus of claim 14,
wherein the hardware engine comprises a hardware engine of a storage device that processes one or more of a read request and a write request,
wherein the event comprise one of the read request or the write request, and
wherein the hardware event queue manager comprises a hardware controller of the storage device.

21. The apparatus of claim 14, wherein the hardware engine processes the event, and returns a result of processing the event to the processing unit.

22. The apparatus of claim 14,
wherein the apparatus comprises a solid state drive;
wherein the hardware engine is included within the solid state drive;
wherein the event includes a request to access the hardware engine so as to interact with a memory of the solid state drive.

23. The apparatus of claim 12, wherein the solid state drive is a peripheral component interconnect Express (PCIe) solid state drive.

24. An apparatus comprising:
means for receiving, from a processing unit by a hardware event queue manager separate from the processing unit, an event to be processed by a hardware engine; and
means for performing, by the hardware event queue manager, queue management with respect to an event queue to schedule processing of the event by the hardware engine.
